(19) United States
(12) Patent Application Publication
(10) Pub. No.: US 2026/0194030 A1
(43) Pub. Date: Jul. 9, 2026

(54) ROCKET ENGINE USING EXPANDER BLEED CYCLE

(71) Applicant: Kenta YASUDA, SHIZUOKA (JP)

(72) Inventor: Kenta YASUDA, SHIZUOKA (JP)

(21) Appl. No.: 19/394,326

(22) Filed: Nov. 19, 2025

(30) Foreign Application Priority Data
Jan. 7, 2025 (JP) 2025-011746

(51) Int. Cl. F02K 9/48; F02K 9/97

(52) U.S. Cl. CPC F02K 9/48; F02K 9/972; F05D 2220/80; F05D 2240/128; F05D 2260/232

(57) ABSTRACT

A rocket engine using expander bleed cycle includes an aerospike nozzle to thereby maintain optimal performance even in an environment where the atmospheric pressure varies. A rocket engine includes: a regenerative cooling nozzle; at least one turbine that rotates by fuel vapor vaporized in the regenerative cooling nozzle; a fuel transfer turbopump that is driven by the turbine; an oxidizer transfer turbopump that is driven by the turbine; and a combustion chamber in which an oxidizer and a fuel are mixed and burned. In the rocket engine, the regenerative cooling nozzle is shaped into an aerospike nozzle, and the rocket engine uses an expander bleed cycle that discharges fuel vapor vaporized in the regenerative cooling nozzle, after use, to outside of the combustion chamber.

### CROSS REFERENCE TO RELATED APPLICATIONS

This application claims priority based on Japanese Patent Application No. 2025-11746 filed on Jan. 7, 2025, and the entire contents of the Japanese patent application are incorporated herein by reference.

### TECHNICAL FIELD

The present disclosure relates to a rocket engine including an aerospike nozzle and using an expander bleed cycle.

### BACKGROUND

Nozzles are used for enhancing propulsive performance of rocket engines. The nozzles are components that control the velocity and pressure of a combustion gas. Japanese Patent No. 4885301, for example, uses a bell nozzle.

One type of nozzle shape is an aerospike nozzle in which a nozzle (spike) is located within a combustion gas. For example, Japanese Patent No. 7091386 uses an aerospike nozzle.

An expander bleed cycle is known as a heat cycle of a rocket engine. The expander bleed cycle is a heat cycle that rotates a turbine of a turbo pump by a fuel vapor vaporized in a regenerative cooling nozzle, transports an oxidizer and fuel to a combustion chamber for combustion via a turbo pump, and exhausts the fuel vapor after turbine rotation through another system. A rocket engine described in Japanese Patent Application Publication No. 2008-202542, for example, is a rocket engine using an expander bleed cycle.

### SUMMARY

A specific impulse, which represents performance of a rocket engine, is at an optimal level when a nozzle outlet pressure is equal to a pressure in the periphery of the rocket engine.

The bell nozzle described in Japanese Patent No. 4885301 has an advantage of ease in heat dissipation because the nozzle is located outside a combustion gas. However, since the nozzle outlet pressure is determined based on the shape of the nozzle, the bell nozzle described in Japanese Patent No. 4885301 fails to select an optimal nozzle outlet pressure in accordance with the atmospheric pressure as appropriate and cannot maintain an optimal specific impulse, in an environment in which the atmospheric pressure changes every moment depending on the altitude.

The aerospike nozzle described in Japanese Patent No. 7091386 has a characteristic of being capable of autonomously maintaining an optimal nozzle outlet pressure in accordance with the atmospheric pressure. However, in the aerospike nozzle described in Japanese Patent No. 7091386, the spike is located within the combustion gas and has difficulty in dissipating heat, and thus, the spike is likely to be damaged by heat.

The rocket engine using the expander bleed cycle described in Japanese Patent Application Publication No. 2008-202542 enlarges the volume of a combustion chamber in proportion to the cube of the engine size in the case of enlarging the engine for increasing a thrust. However, the surface area of a regenerative cooling nozzle enlarges in proportion to the square of the engine size, leading to a tendency of heat quantity shortage in the regenerative cooling nozzle.

It is therefore an object of the present disclosure to provide a rocket engine using an expander bleed cycle and including an aerospike nozzle to thereby maintain optimal performance even in an environment where the atmospheric pressure changes.

A rocket engine according to the present disclosure includes: a regenerative cooling nozzle; at least one turbine that rotates by fuel vapor vaporized in the regenerative cooling nozzle; a fuel transfer turbopump that is driven by the at least one turbine; an oxidizer transfer turbopump that is driven by the at least one turbine; and a combustion chamber in which an oxidizer and fuel are mixed and burned. In the rocket engine according to the present disclosure, the regenerative cooling nozzle is shaped into an aerospike nozzle shape, and the rocket engine uses an expander bleed cycle that discharges fuel vapor vaporized in the regenerative cooling nozzle, after use, to outside of the combustion chamber.

The present disclosure can provide a rocket engine that maintains optimal performance even in an environment where the atmospheric pressure changes.

### BRIEF DESCRIPTION OF DRAWINGS

FIG. 1 is a cross-sectional view for describing a schematic configuration of a rocket engine 1.

FIG. 2 is a schematic view illustrating a shape of a combustion gas in a case where an ambient pressure is a standard atmosphere.

FIG. 3 is a schematic view illustrating a shape of the combustion gas in a case where the ambient pressure is at a low air density.

FIG. 4 is a schematic view illustrating a shape of the combustion gas in a case where the ambient pressure is vacuum.

### DETAILED DESCRIPTION

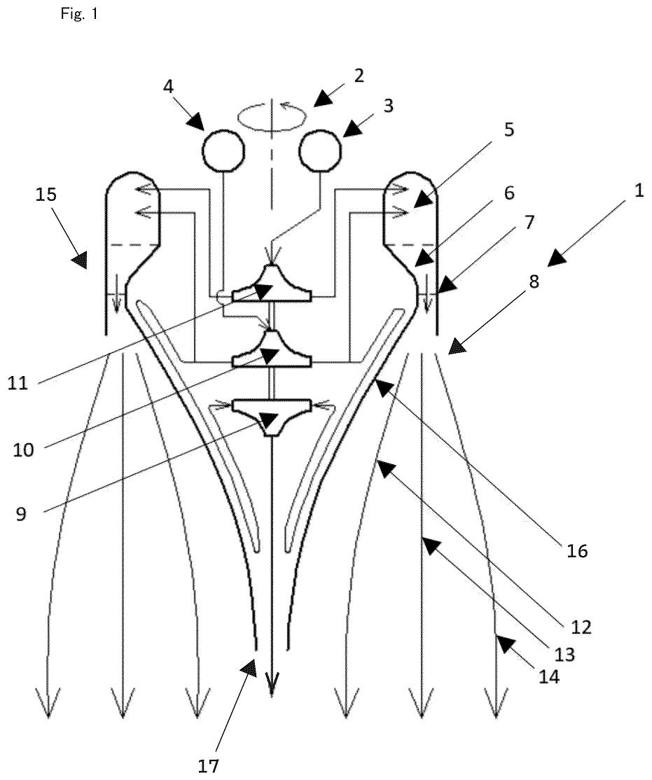

A rocket engine according to an embodiment of the present disclosure will be described in more detail with reference to the drawings. FIG. 1 is a cross-sectional view illustrating a schematic configuration of a rocket engine 1.

Specifications of the rocket engine 1 are, for example, as follows. The rocket engine 1 has a thrust of 150 tons in vacuum, an overall length of 3 m, and a diameter of 2 m, and uses an expander bleed cycle.

The rocket engine 1 has a basic structure that is axially symmetrical with respect to a rotation axis 2.

An oxidizer 3 is liquid oxygen. The oxidizer 3 may be dinitrogen tetroxide, hydrogen peroxide, dinitrogen monoxide, or other liquid oxidizers.

Fuel 4 is liquid hydrogen. The fuel 4 may be liquid methane, hydrocarbon, methyl alcohol, or other liquid fuel.

A combustion chamber 5 withstands heat and pressure generated by combustion of the fuel 4. The combustion chamber 5 is made of steel. The combustion chamber 5 may be made of other metals or carbon fiber composite materials.

Combustion in the combustion chamber 5 may be either an explosion or a detonation.

The regenerative cooling nozzle 15 is shaped in an aerospike nozzle shape. Specifically, the regenerative cooling nozzle 15 is an aerospike nozzle in which the combustion chambers 5 are arranged in, for example, a circular shape and a spike 16 projecting at the center of the circular shape and a peripheral space thereof are used as a nozzle. The regenerative cooling nozzle 15 includes a first portion 6, a second portion 7, and a third portion 8.

The first portion 6 of the regenerative cooling nozzle 15 is made of steel. The first portion 6 may be made of other metals or carbon fiber composite materials. The first portion 6 has a shape whose cross-sectional area changes to increase the velocity of a combustion gas generated in the combustion chamber 5.

Specifically, the first portion 6 has a tapered shape such that the cross-sectional area thereof gradually decreases toward the second portion 7. Accordingly, the combustion gas generated in the combustion chamber 5 converges while passing in the first portion 6, and as a result, the velocity of the combustion gas increases.

The second portion 7 of the regenerative cooling nozzle 15 is made of steel. The second portion 7 may be made of other metals or carbon fiber composite materials. The second portion 7 has a shape whose cross-sectional area changes such that the velocity of the combustion gas passing through the second portion 7 is equal to the acoustic velocity.

That is, the second portion 7 is a thinnest portion (throat portion) in the regenerative cooling nozzle 15.

The third portion 8 of the regenerative cooling nozzle 15 has a basic structure that is axially symmetrical with respect to the rotation axis 2. The third portion 8 is made of steel. The third portion 8 may be made of other metals or carbon fiber composite materials. The third portion 8 has a shape whose cross-sectional area changes to reduce the pressure of the combustion gas decreases and increase the velocity of the combustion gas. The third portion 8 has an aerospike shape in which the spike 16 is located within the combustion gas.

That is, the third portion 8 has the function of expanding the combustion gas that has passed through the second portion 7 and reached the acoustic velocity to further accelerate the combustion gas. The spike 16 has a tapered shape that tapers toward a tip 17 such that the combustion gas dissipates while passing in the third portion 8. Accordingly, the cross-sectional area of the third portion 8 gradually increases to a side opposite to the second portion 7.

The third portion 8 includes a fuel pipe joined to the inner side of the spike 16 and, thus, has the function of transferring heat of the combustion gas to the fuel.

The fuel pipe is made of, for example, steel, and a large number of fuel pipes joined in a cylindrical shape by, for example, welding may be joined to the inner side of the spike 16 by, for example, welding. Alternatively, as a structure that transfers heat of the combustion gas to the fuel, the inner wall of a cylinder whose outer peripheral surface has a large number of grooves serving as fuel channels may be joined to the inner side of the spike 16 by, for example, welding.

A turbine 9 rotates by fluid energy of fuel vapor vaporized by receiving heat from the combustion gas in the third portion 8 of the regenerative cooling nozzle 15.

The fuel vapor after the rotation of the turbine 9 is discharged from the tip of the third portion 8 of the regenerative cooling nozzle 15, that is, the tip 17 of the spike 16. The turbine 9 is located in the third portion 8 of the regenerative cooling nozzle 15. The rotation axis of the turbine 9 coincides with the axis of axial symmetry of the rocket engine 1.

A fuel transfer turbopump 10 is driven by the turbine 9 to pressurize the fuel 4 and transport the fuel 4 to the combustion chamber 5. The fuel transfer turbopump 10 is located in the third portion 8 of the regenerative cooling nozzle 15. The rotation axis of the fuel transfer turbopump 10 coincides with the axis of axial symmetry of the rocket engine 1.

The oxidizer transfer turbopump 11 is driven by the turbine 9 to pressurize the oxidizer 3 and transport the oxidizer 3 to the combustion chamber 5. The oxidizer transfer turbopump 11 is located in the third portion 8 of the regenerative cooling nozzle 15. The rotation axis of the oxidizer transfer turbopump 11 coincides with the axis of axial symmetry of the rocket engine 1.

In the rocket engine 1 according to this embodiment, the shape of the combustion gas during operation of the rocket engine 1 is optimized in accordance with the atmospheric pressure. Therefore, the specific impulse of the rocket engine 1 is maintained at an optimal level.

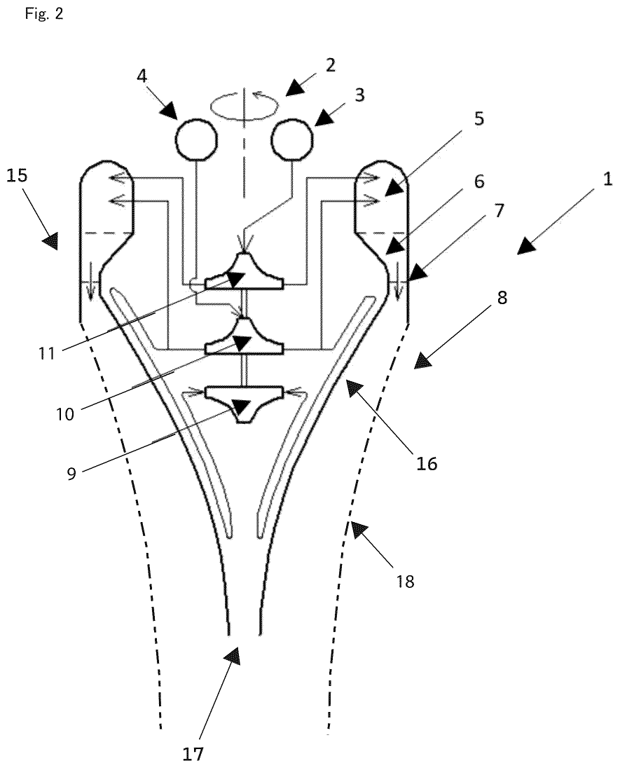

A combustion gas outer edge line (standard atmospheric pressure) 12 shown in FIG. 1 indicates an outer edge of a combustion gas in a case where the ambient pressure around the rocket engine 1 is a standard atmospheric pressure. FIG. 2 shows a shape of a combustion gas 18 in the case where the ambient pressure around the rocket engine 1 is the standard atmospheric pressure.

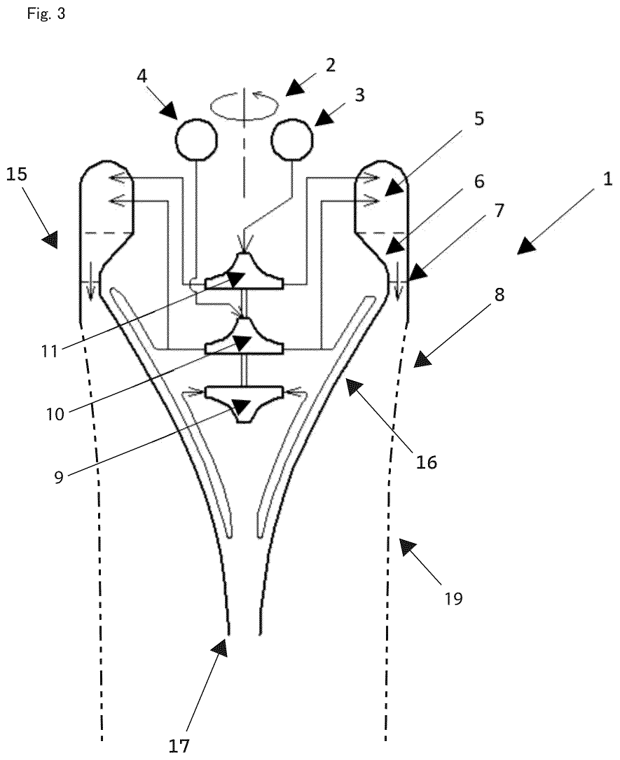

A combustion gas outer edge line (low air density) 13 shown in FIG. 1 indicates an outer edge of a combustion gas in a case where the ambient pressure around the rocket engine 1 is at a low air density. FIG. 3 shows a shape of a combustion gas 19 in the case where the ambient pressure around the rocket engine 1 is at a low air density.

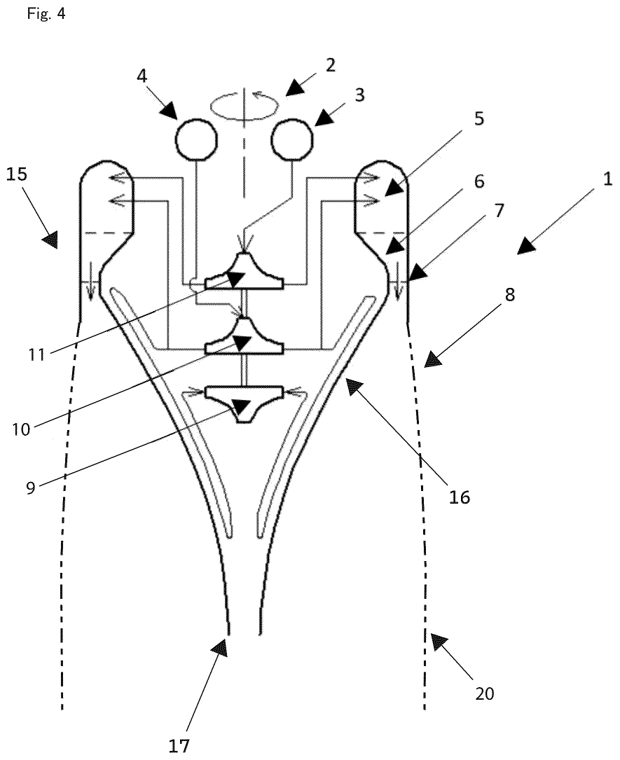

A combustion gas outer edge line (in vacuum) 14 indicates an outer edge of a combustion gas in a case where the ambient pressure around the rocket engine 1 is vacuum. FIG. 4 shows a shape of a combustion gas 20 in the case where the ambient pressure around the rocket engine 1 is vacuum.

In the manner described above, since the rocket engine 1 according to this embodiment includes the aerospike nozzle, the rocket engine 1 can keep a specific impulse at an optimal level even with a change of the ambient pressure, and thus, can maintain optimal performance.

Further, in the aerospike nozzle, since the spike 16 is located within the combustion gas, it is generally difficult to cool the spike 16. On the other hand, the rocket engine 1 according to this embodiment uses the expander bleed cycle, and heat is taken from the spike 16 by vaporization of the fuel. Thus, the spike 16 can be easily cooled.

Rotation of the turbine 9 requires that heat of the combustion gas is absorbed in a part of the fuel from the third portion 8 of the regenerative cooling nozzle 15. However, it is difficult for the third portion 8 of the regenerative cooling nozzle 15 to dissipate radiant heat of the combustion gas to the periphery. For this reason, the rocket engine 1 according to this embodiment has an advantage of ease in securing heat.

In the rocket engine 1 according to this embodiment, the turbine 9, the fuel transfer turbopump 10, and the oxidizer transfer turbopump 11 are placed by effectively utilizing an internal space of the third portion 8 of the regenerative cooling nozzle 15. Thus, the rocket engine 1 according to this embodiment is advantageous in reducing the overall engine length and the structural weight.

In the rocket engine 1 according to this embodiment, the rotation axes of the turbine 9, the fuel transfer turbopump 10, and the oxidizer transfer turbopump 11 coincide with the axis of axial symmetry of the regenerative cooling nozzle 15. Thus, the rocket engine 1 according to this embodiment is well balanced in structure and is advantageous in reducing the structural weight.

The pressure near the tip of the third portion 8 of the regenerative cooling nozzle 15 is reduced to a level substantially equal to the ambient pressure around the rocket engine 1. Thus, the rocket engine 1 according to this embodiment is advantageous because of a small discharge pressure in discharging fuel vapor after rotation of the turbine 9 from the tip of the third portion 8 of the regenerative cooling nozzle 15.

The rocket engine according to the present disclosure is not limited to particular applications, and can be preferably used as a high-performance rocket engine in a satellite launch rocket, a rocket for movement in space, a defense weapon, and others.

Although the foregoing description is directed to the rocket engine according to the present disclosure, the embodiment may be modified in various ways without departing from the gist of the present disclosure. For example, modifications described below may be made. The modifications described below may be combined as appropriate.

For example, fuel may be vaporized not only in the regenerative cooling nozzle 15 but also in the combustion chamber 5. This allows heat absorption to be performed in the combustion chamber 5.

For example, it is unnecessary to drive the fuel transfer turbopump 10 and the oxidizer transfer turbopump 11 by one turbine 9. The rocket engine 1 may include two independent turbines: a turbine for the fuel transfer turbopump 10 and a turbine for the oxidizer transfer turbopump 11. In this case, the rotation axis of one turbine for driving the oxidizer transfer turbopump 11, the rotation axis of the other turbine for driving the fuel transfer turbopump 10, the rotation axis of the oxidizer transfer turbopump 11, and the rotation axis of the fuel transfer turbopump 10 preferably coincide with the axis of axial symmetry of the regenerative cooling nozzle 15.

It should be understood that the embodiments disclosed here are illustrative and non-restrictive in every respect. The scope of the present disclosure is defined by the claims, rather than the description above, and is intended to include any modifications within the scope and meaning equivalent to the claims.

What is claimed is:

1. A rocket engine comprising:
a regenerative cooling nozzle;
at least one turbine that rotates by fuel vapor vaporized in the regenerative cooling nozzle;
a fuel transfer turbopump that is driven by the at least one turbine;
an oxidizer transfer turbopump that is driven by the at least one turbine; and
a combustion chamber in which an oxidizer and fuel are mixed and burned, wherein
the regenerative cooling nozzle is shaped into an aerospike nozzle shape, and
the rocket engine uses an expander bleed cycle that discharges fuel vapor vaporized in the regenerative cooling nozzle, after use, to outside of the combustion chamber.

2. The rocket engine according to claim 1, wherein the at least one turbine, the oxidizer transfer turbopump, and the fuel transfer turbopump are located inside the regenerative cooling nozzle when the regenerative cooling nozzle is seen from a side surface of the regenerative cooling nozzle.

3. The rocket engine according to claim 1, wherein
the at least one turbine comprises one turbine that drives the oxidizer transfer turbopump and the fuel transfer turbopump, wherein
a rotation axis of the turbine, a rotation axis of the oxidizer transfer turbopump, and a rotation axis of the fuel transfer turbopump coincide with an axis of axial symmetry of the regenerative cooling nozzle.

4. The rocket engine according to claim 1, wherein
the at least one turbine comprises two turbines, and
a rotation axis of one of the two turbines that drives the oxidizer transfer turbopump, a rotation axis of another of the two turbines that drives the fuel transfer turbopump, a rotation axis of the oxidizer transfer turbopump, and a rotation axis of the fuel transfer turbopump coincide with an axis of axial symmetry of the regenerative cooling nozzle.

5. The rocket engine according to claim 1, wherein fuel vapor after rotation of the at least one turbine is discharged from a tip of the regenerative cooling nozzle.

6. The rocket engine according to claim 2, wherein
the at least one turbine comprises one turbine that drives the oxidizer transfer turbopump and the fuel transfer turbopump, wherein
a rotation axis of the turbine, a rotation axis of the oxidizer transfer turbopump, and a rotation axis of the fuel transfer turbopump coincide with an axis of axial symmetry of the regenerative cooling nozzle.

7. The rocket engine according to claim 2, wherein
the at least one turbine comprises two turbines, and
a rotation axis of one of the two turbines that drives the oxidizer transfer turbopump, a rotation axis of another of the two turbines that drives the fuel transfer turbopump, a rotation axis of the oxidizer transfer turbopump, and a rotation axis of the fuel transfer turbopump coincide with an axis of axial symmetry of the regenerative cooling nozzle.

8. The rocket engine according to claim 2, wherein fuel vapor after rotation of the at least one turbine is discharged from a tip of the regenerative cooling nozzle.

9. The rocket engine according to claim 3, wherein fuel vapor after rotation of the at least one turbine is discharged from a tip of the regenerative cooling nozzle.

10. The rocket engine according to claim 4, wherein fuel vapor after rotation of the at least one turbine is discharged from a tip of the regenerative cooling nozzle.
